(19) United States
(12) Patent Application Publication
(10) Pub. No.: US 2015/0216628 A1
(43) Pub. Date: Aug. 6, 2015

(54) APPARATUS AND METHOD FOR ORTHODONTIC TREATMENT

(71) Applicant: TenBrook Orthodontic Products LLC, Millville, NJ (US)

(72) Inventors: James J. TenBrook, Millville, NJ (US); Stephen Huff, San Diego, CA (US)

(73) Assignee: TenBrook Orthodontic Products LLC, Millville, NJ (US)

(21) Appl. No.: 14/609,453

(22) Filed: Jan. 30, 2015

Related U.S. Application Data
(60) Provisional application No. 61/935,329, filed on Feb. 3, 2014.
(60) Provisional application No. 61/936,320, filed on Feb. 5, 2014.

(51) Int. Cl. A61C 7/14

(52) U.S. Cl. CPC A61C 7/14

(57) ABSTRACT

An apparatus and method for orthodontic treatment is disclosed. The orthodontic apparatus comprises a bracket configured for attachment to a tooth in a set of brackets configured for attachment to a set of teeth and configured to be engaged by an archwire installed in the set of brackets to facilitate orthodontic treatment. A bracket comprises a base for attachment to the tooth and at least one slot for the archwire with a ridge and a depression and a chamfer. The ridge of the slot is configured to engage in contact with the archwire so that force from the archwire is applied by contact at the ridge to the bracket. The method of providing orthodontic treatment uses a set of brackets for a set of teeth connected by an archwire. The method comprises configuring each bracket in the set of brackets with a ridge-depression arrangement providing a ridge in a slot, attaching each bracket to a tooth and connecting the set of brackets with an archwire inserted in the slot. Treatment is facilitated by selectively located application of force from the archwire to the tooth at the ridge when the bracket is attached to the tooth and the archwire is installed in the set of brackets

### RELATED APPLICATIONS

The present application claims priority to and incorporates by reference: (a) U.S. Provisional Application No. 61/935,329 titled “Apparatus and Method for Orthodontic Treatment” filed on Feb. 3, 2014 and (b) U.S. Provisional Application No. 61/936,320 titled “Apparatus and Method for Orthodontic Treatment” filed on Feb. 5, 2014.

### FIELD

The present invention relates to an apparatus and method for orthodontic treatment.

### BACKGROUND

The use of orthodontic brackets and orthodontic wires (e.g. archwires) in various forms and styles as apparatus for orthodontic treatment is well-known. Brackets are typically affixed to the teeth of the patient; wires are used to connect the brackets and as a means to apply a force used for tooth movement in the orthodontic treatment. The treatment gradient (implemented method/means of orthodontic treatment for a patient as may be planned) is at least partially influenced by the type of brackets used in the treatment; the treatment gradient may also comprise constraints and considerations of force and friction, tooth movement/control, inter-bracket distance, wire type, etc.

Brackets of various types are known. For example, it is known to provide a so-called edgewise bracket; it is also known to provide a so-called bracket in the form of the “Begg bracket”. Each bracket type (e.g. form/style or design) may provide a different treatment gradient in view of the considerations. For example, the “Begg bracket” (single wing style) may be considered to provide such features as less force, less friction, facilitated tipping in tooth movement, less individual tooth control, greater inter-bracket distance, etc. The edgewise bracket (twin style) may be considered to provide such features as more force, more binding friction, less freedom of tooth movement, greater individual tooth control, less inter-bracket distance, etc. A “twin” orthodontic bracket provides wings separated by an intermediate slot. There are advantages and disadvantages to each style or type of bracket.

There also has been an evolution of orthodontic wires (e.g. providing available options such as the Australian wire and twisted flexible wires). The use of Nitinol (e.g. NiTi “shape memory” alloy or the like) for orthodontic wires (e.g. archwires) is known. The evolution of orthodontic wires has included thermally-activated NiTi (Nitinol) which exhibits material properties that may be used to provide the forces used for tooth movement (e.g. “memory” properties of the material tending to restore a shape) in orthodontic treatment. Use of NiTi wires with many common orthodontic brackets may result in deformation such as “square corners” and/or kinked wire which affects the performance of the wire in terms of efficiency in tooth movement and the treatment gradient for orthodontic treatment. For example, in practice “square corners” may produce deformations in the wire material such that the wire is unable to recover fully its memory shape and may develop a permanent set or kinks that result in a reduction of the efficiency of the wire and that affect the treatment gradient.

### SUMMARY

Improvement in bracket design and related technology allows for improvement in the field of orthodontic treatment. For example, an improved orthodontic bracket design may comprise at least one of such features as: (1) chamfered slot; (2) ridge design; (3) anti-saddle area; (4) “anti-rotation” control; (5) optimum torque; and (6) optimal tip control. As indicated in the specification and FIGURES, an orthodontic bracket can be modified in design to achieve improved performance, for example increased efficiency of the archwire and the treatment gradient.

The present invention relates to an orthodontic apparatus comprising a bracket configured for attachment to a tooth in a set of brackets configured for attachment to a set of teeth and configured to be engaged by an archwire installed in the set of brackets to facilitate orthodontic treatment. The orthodontic apparatus comprises a base for attachment to the tooth and at least one slot for the archwire with a ridge and a depression and a chamfer. The ridge of the slot is configured to engage in contact with the archwire so that force from the archwire is applied by contact at the ridge to the bracket. Treatment is facilitated by selectively located application of force from the archwire to the tooth at the ridge when the bracket is attached to the tooth and the archwire is installed in the set of brackets.

The present invention relates to an orthodontic apparatus comprising a bracket set for a set of teeth configured to engage an archwire for orthodontic treatment. The orthodontic apparatus comprises a bracket with a base for attachment to a tooth and at least one slot. A slot comprises at least one edge with a chamfer, at least one ridge and at least one depression. The at least one ridge of the slot is configured to engage the archwire when in the slot so that force from the archwire is applied in contact with the at least one ridge to the bracket. Each bracket in the set of brackets is attachable to a tooth and can be configured with the at least one ridge and at least one depression located within the slot. Treatment is facilitated by selectively located force from the archwire engaged in contact with the at least one ridge in the at least one slot of each bracket.

The present invention relates to a method of providing orthodontic treatment using a set of brackets for a set of teeth connected by an archwire. The method comprises configuring each bracket in the set of brackets with a ridge-depression arrangement providing a ridge in a slot, attaching each bracket to a tooth and connecting the set of brackets with an archwire inserted in the slot. The ridge of the slot is configured to engage the archwire so that force from the archwire is applied at the ridge to the bracket and the tooth. The treatment is facilitated by selectively located application of force from the archwire to the ridge to the bracket when the bracket is attached to the tooth.

### FIGURES

FIG. 1 is a schematic front perspective partial view of an orthodontic apparatus showing installation of brackets and archwire according to an exemplary embodiment.

FIG. 2 is a schematic front perspective view of an orthodontic bracket with archwire according to an exemplary embodiment.

FIG. 3 is a schematic perspective view of the bracket according to an exemplary embodiment.

FIG. 3A is a schematic perspective detail view of the bracket according to an exemplary embodiment.

FIGS. 4A and 4B are schematic side perspective views of the bracket according to an exemplary embodiment.

FIG. 5 is a schematic rear perspective view of the bracket according to an exemplary embodiment.

FIG. 6 is a schematic top plan view of the bracket according to an exemplary embodiment.

FIG. 7 is a schematic side elevation view of the bracket according to an exemplary embodiment.

FIG. 8A is a schematic side elevation cross-section view of the bracket according to an exemplary embodiment.

FIG. 8B is a schematic side elevation cross-section view of the bracket according to an exemplary embodiment.

FIG. 9 is a schematic front perspective view of the bracket with archwire according to an exemplary embodiment.

FIG. 10A is a schematic perspective diagram of a tooth showing rotational axes of tooth movement in orthodontic treatment according to an exemplary embodiment.

FIG. 10B is a schematic perspective cut-away view of the bracket showing rotational axes of tooth movement according to an exemplary embodiment.

FIG. 11 is a schematic side elevation view of the bracket showing contact points of an archwire according to an exemplary embodiment.

FIG. 12 is a schematic front elevation view of the bracket showing interaction with the archwire according to an exemplary embodiment.

FIGS. 12A-12B are schematic cross-section detail views of the bracket of FIG. 12 according to an exemplary embodiment.

FIGS. 13A-13D are schematic diagrams of the orthodontic apparatus showing progression of tooth movement in orthodontic treatment according to an exemplary embodiment.

FIGS. 14A-14B are schematic diagrams of the orthodontic apparatus showing progression of tooth movement in orthodontic treatment according to an exemplary embodiment.

FIGS. 15A-15B are schematic diagrams of the orthodontic apparatus showing progression of tooth movement in orthodontic treatment according to an exemplary embodiment.

FIG. 16 is a schematic front elevation view of the orthodontic apparatus showing two brackets with archwire according to an exemplary embodiment.

FIGS. 16A-16D are schematic cross-section detail views of the orthodontic apparatus of FIG. 16 according to an exemplary embodiment.

FIG. 17 is a schematic side elevation cross-section view of the bracket according to an exemplary embodiment.

FIGS. 17A-17F are schematic cross-section detail views of the bracket of FIG. 17 according to exemplary and alternative embodiments.

FIG. 18 is a schematic side elevation cross-section view of the bracket showing according to an exemplary embodiment.

FIGS. 18A-18I are schematic cross-section detail views of the bracket of FIG. 18 according to exemplary and alternative embodiments.

FIG. 19A is a schematic side elevation detail view of the bracket showing interaction with the archwire according to an alternative embodiment.

FIG. 19B is a schematic side elevation detail view of the bracket showing interaction with the archwire according to an exemplary embodiment.

FIG. 20A is a schematic front view of the bracket according to an alternative embodiment.

FIG. 20B is a schematic front view of the bracket according to an exemplary embodiment.

FIG. 21A is a schematic side elevation cross-section view of the bracket showing interaction with the archwire according to an exemplary embodiment.

FIG. 21B is a schematic side elevation cross-section detail view of the bracket showing interaction with the archwire according to an exemplary embodiment.

FIG. 22A is a schematic front perspective view of the bracket showing interaction with the archwire according to an exemplary embodiment.

FIG. 22B is a schematic side elevation view of the orthodontic apparatus bracket showing interaction with the archwire according to an exemplary embodiment.

### DESCRIPTION

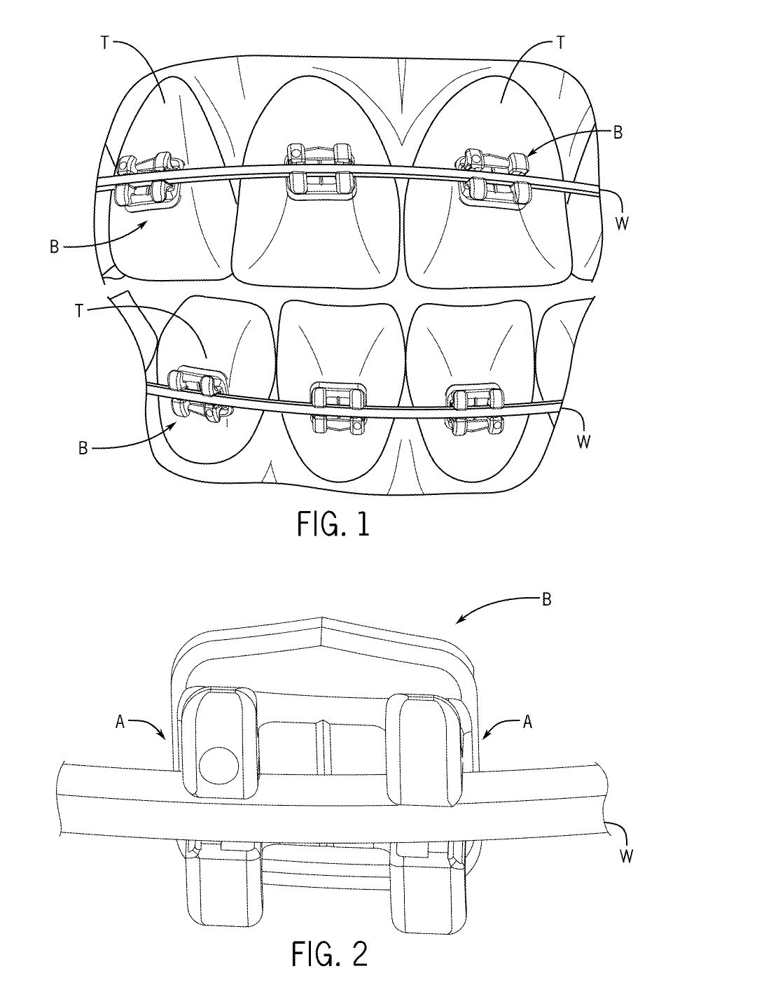

Referring to the specification and FIGURES which indicate schematically various exemplary embodiments, an apparatus and method implemented with orthodontic bracket B is shown and described. As indicated in FIG. 1, a set of brackets B is affixed to a corresponding set of teeth T of the patient to be provided orthodontic treatment. The brackets are interconnected with archwires shown as wires W.

According to any preferred embodiment of the apparatus and method, the bracket design and other embodiments of the present inventions are intended to facilitate increased efficiency in orthodontic treatment.

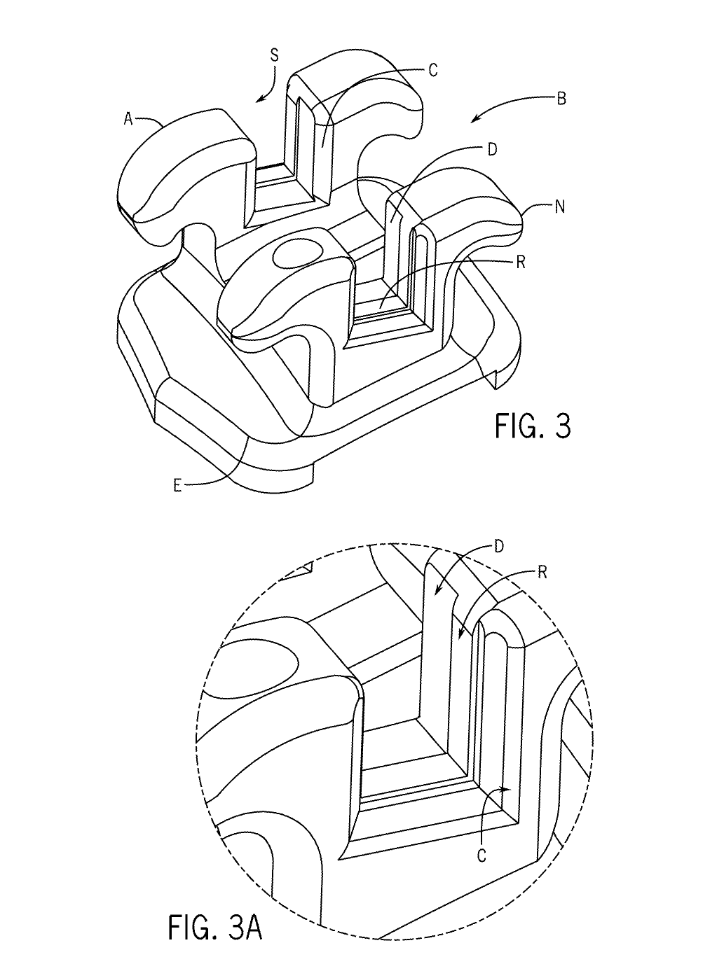

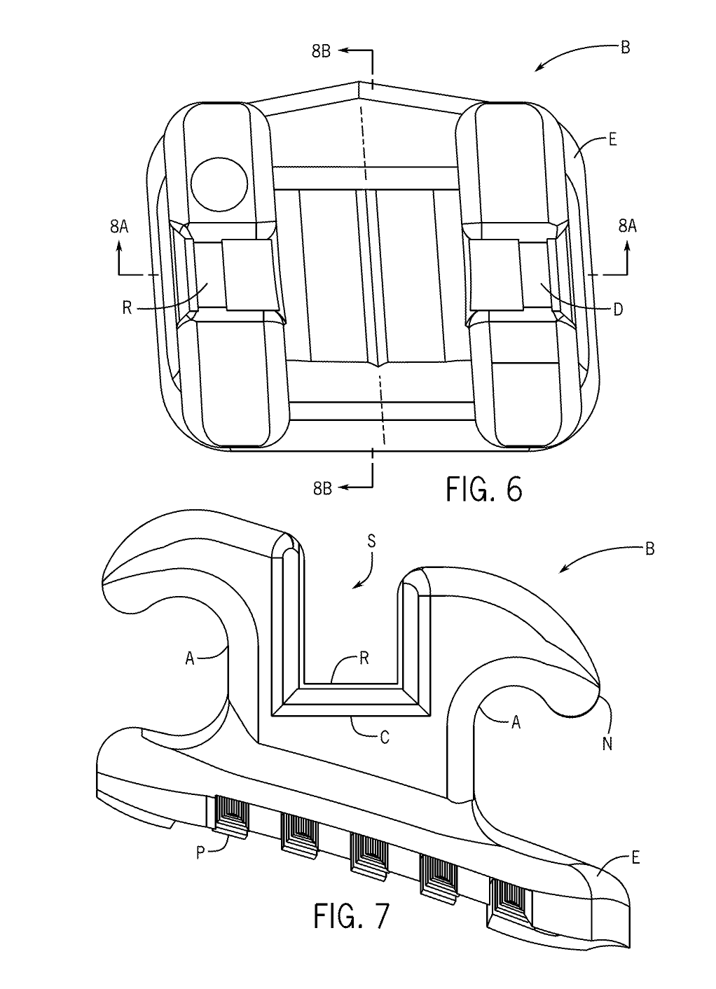

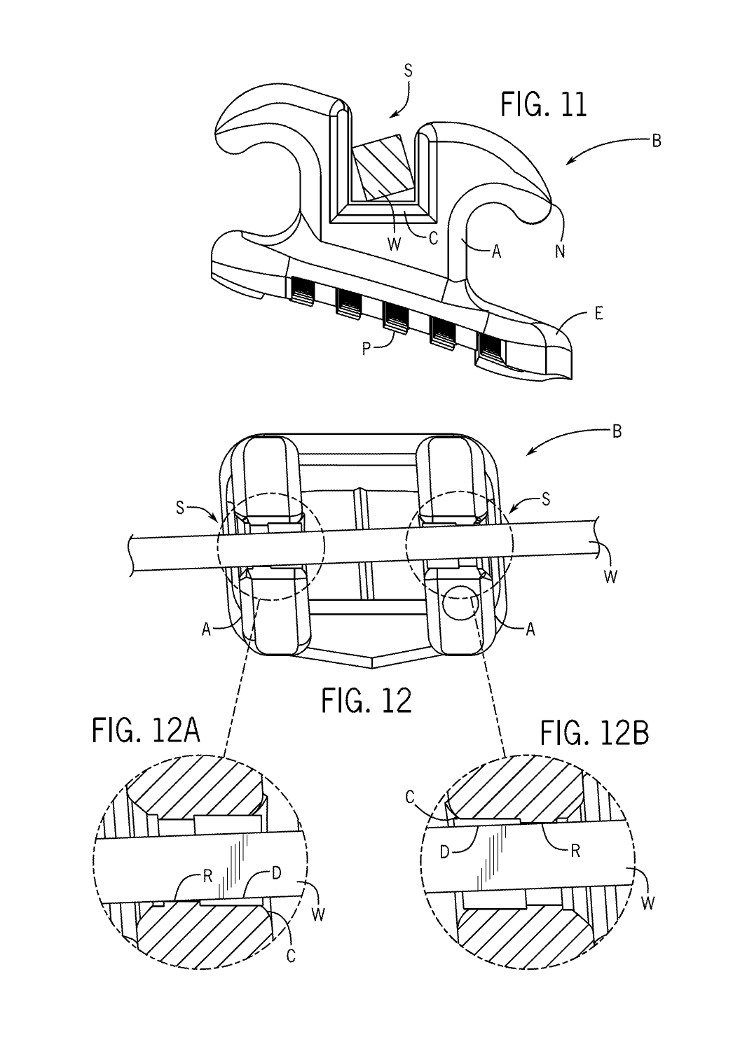

According to an exemplary embodiment, as indicated in FIGS. 1, 9 and 22A, bracket B comprises a base E attachable to a tooth T and at least one projecting member shown as arms A providing at least one slot S (see also FIGS. 2, 3, 4A-4B, 5, 7, 11, 12, 16); each slot S provides a set of chamfers C (e.g. rounded/angled edge treatment) and an arrangement (e.g. ridge-depression arrangement on the exposed surface area) providing ridge R and depression D. See FIGS. 3, 6, 9, 12A-12B, 17A-17F, 18, 18A-18I and 20B. Pads P may be provided under base E of bracket B to facilitate attachment to a tooth (e.g. using conventional methods). See FIGS. 1, 5, 9 and 11. An archwire W of a selected type is installed in slots S of the brackets to facilitate orthodontic treatment. See FIGS. 1, 2, 12, 13A-13D, 14A-14B, 15A-15B, 16, 16A-16D and 22A-22B.

According to any exemplary embodiment, an improved orthodontic bracket design may comprise at least one of such features as: (1) chamfered slot; (2) ridge design; (3) anti-saddle area; (4) “anti-rotation” control; (5) optimum torque; and (6) optimal tip control.

As indicated in the specification and FIGURES (including schematically), according to exemplary embodiments, an orthodontic bracket can be modified or adapted in design (e.g. by configuration of the ridge-depression arrangement) to achieve improved performance, for example increased efficiency of the archwire and the treatment gradient.

Chamfered Slot.

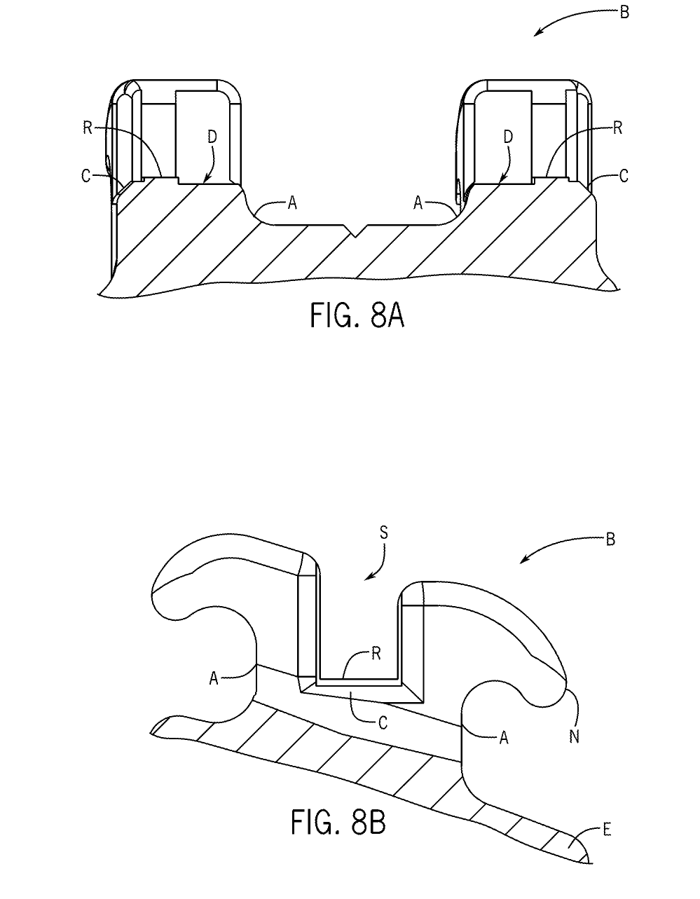

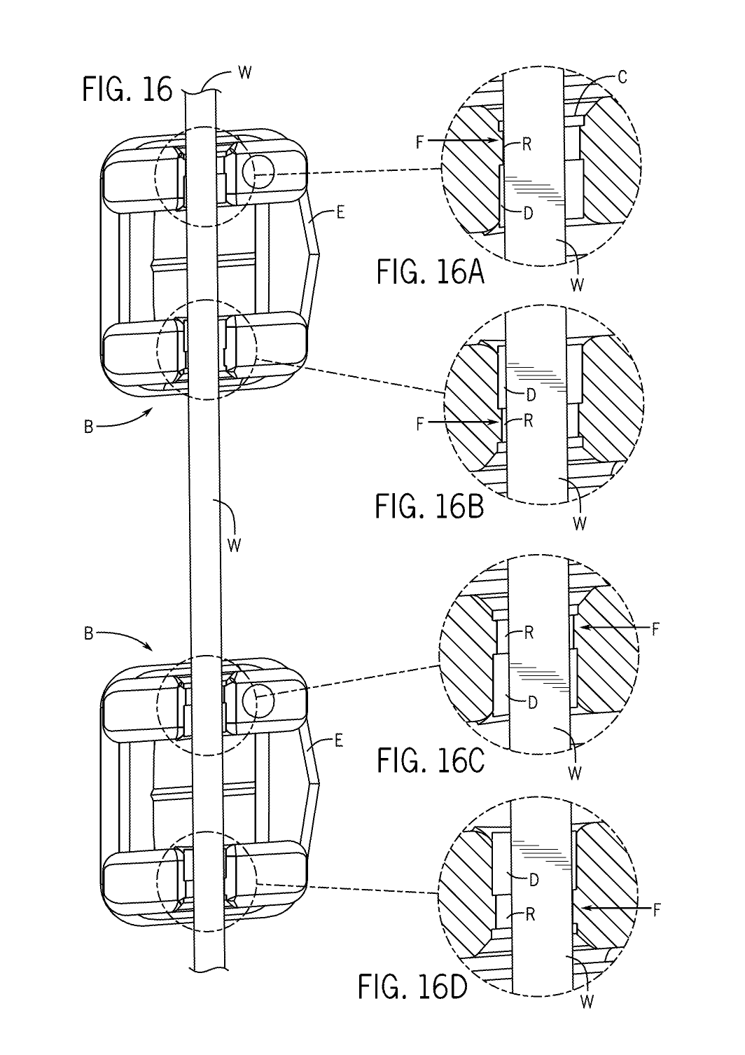

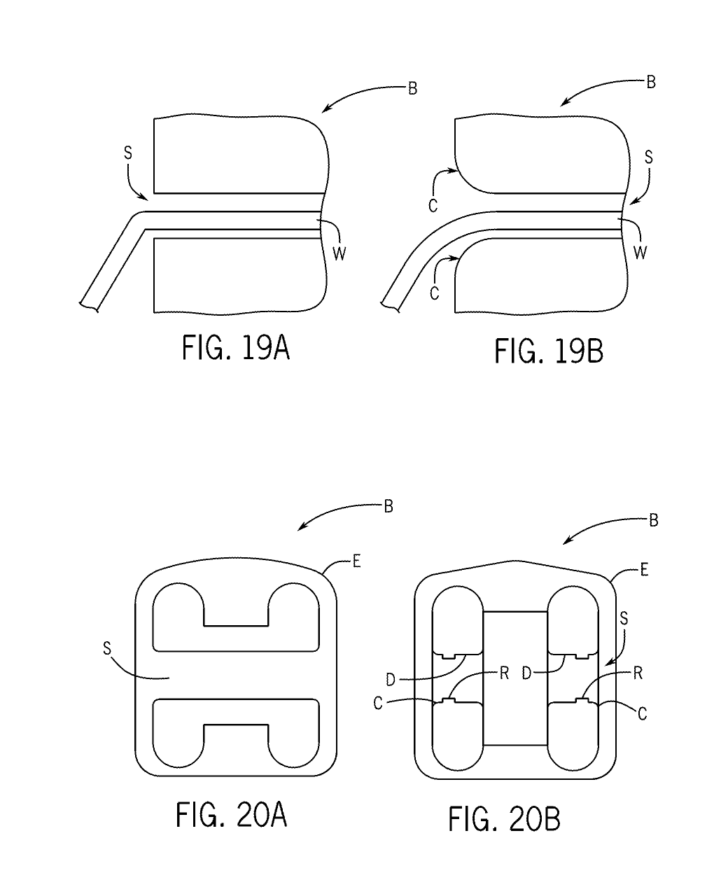

As indicated in the FIGURES, according to an exemplary embodiment, the bracket B may comprise a set of chamfers C (e.g. angled and/or curved edges) for the slot S for the archwire W. See FIGS. 3, 3A, 7, 8A, 9, 11, 12A-12B, 17, 18, 19B and 20B. The chamfers may be configured as “lead in” chamfers to increase inter-bracket distance and allow for radial displacement of the arch wire (see FIG. 19B) (e.g. to facilitate clinical activation of a NiTi archwire in a more radial in manner and intended to achieve more efficient treatment results). As indicated, the chamfer with rounded configuration/form (see e.g. FIGS. 3-3A and 19B) is intended to deform the archwire in a more radial fashion and to facilitate increased wire flexibility and increased inter-bracket distance (see e.g. FIG. 16).

Ridge Design/Anti-Saddle Area.

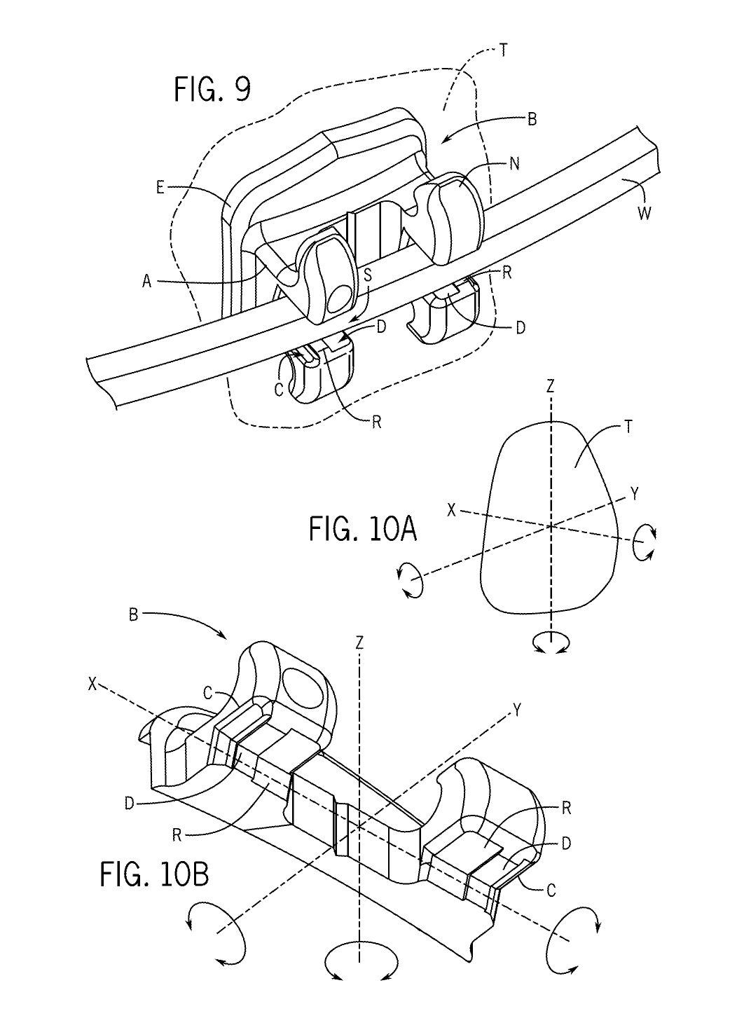

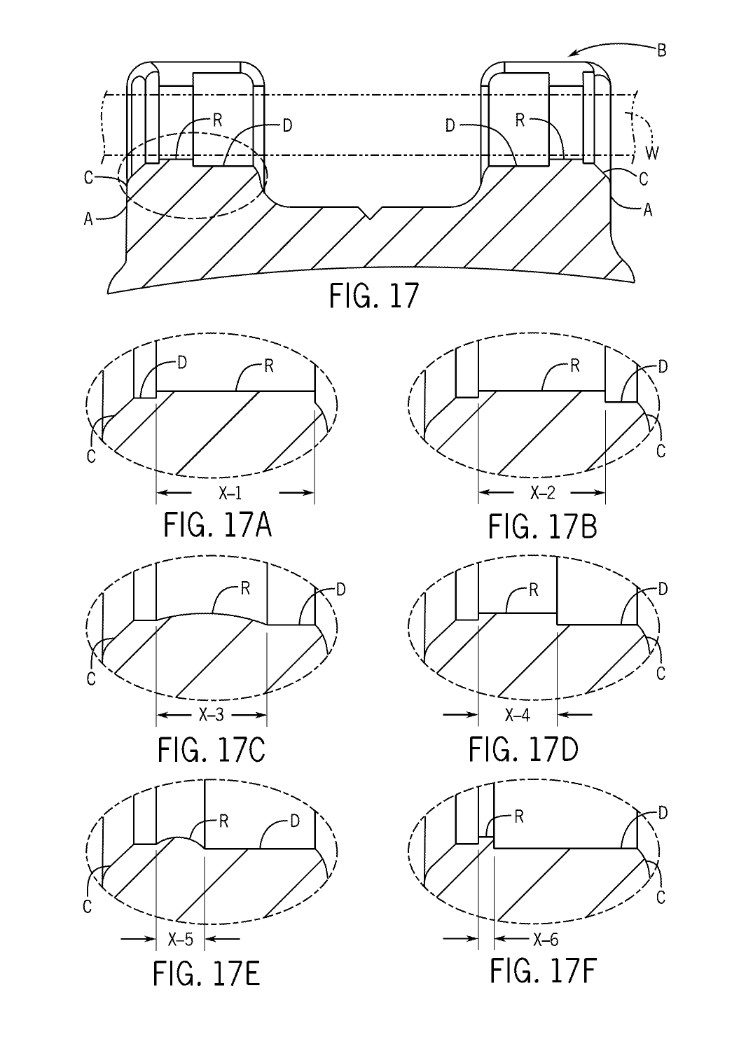

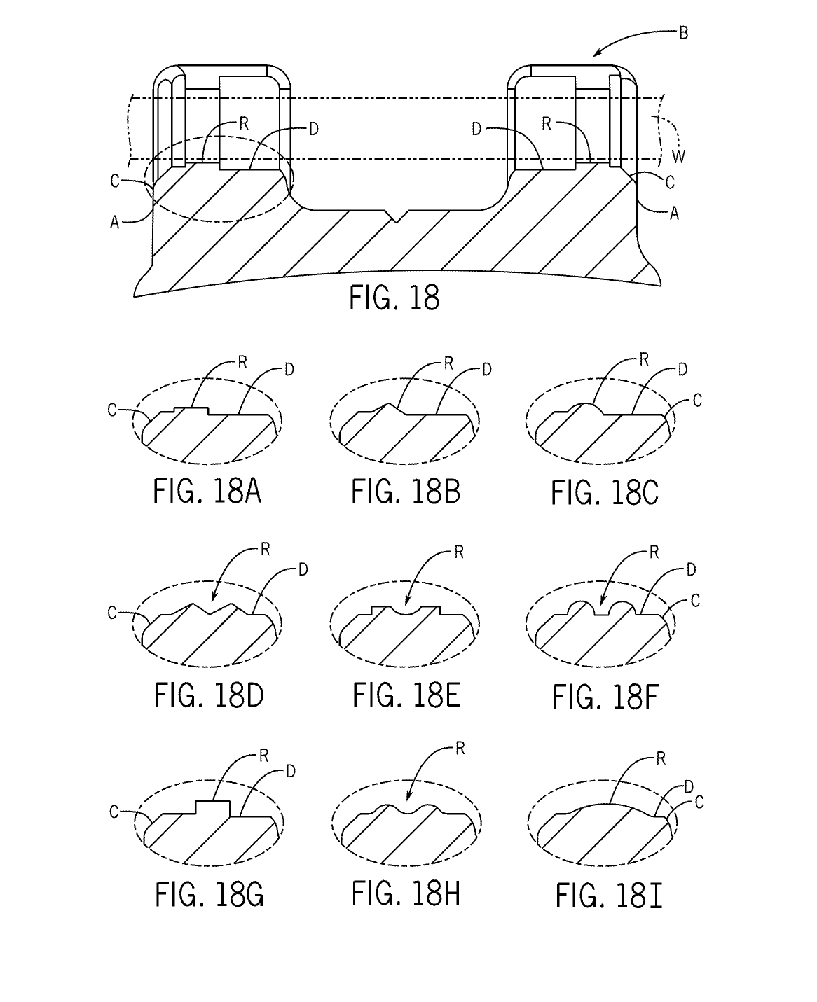

As indicated, according to an exemplary embodiment, the bracket B provides an uplifted ridge R and a depressed area D (e.g. a ridge-depression arrangement providing an “anti-saddle” area) within slot S. See FIGS. 3, 4, 9, 11 and 17-18. According to an exemplary embodiment, the ridge-depression arrangement is provided in a portion (e.g. exposed surface area) of the slot that will engage an installed archwire. See FIGS. 9 and 16. According to an exemplary embodiment, the ridge design/configuration of the bracket is intended to facilitate a more precise application of force F from the archwire to the bracket (and to the tooth on which the bracket is mounted, see for example, FIGS. 16A and 16D); the configuration of the ridge design/arrangement is shown according to exemplary and other alternative embodiments in FIGS. 17 and 17A-17D and FIGS. 18 and 18A-18I. According to an exemplary embodiment as shown schematically for example in FIGS. 1, 3, 9 and 16, the bracket B is of a “twin” type providing a wing N and slot S for a wire shown as archwire W.

As indicated schematically, according to exemplary and alternative embodiments, the form and relationship between the size of the ridge R and the depression D within the slot S for the archwire W may be provided in any of a number of variations (see FIGS. 17, 17A-17F, 18, 18A-18I); for example, the ridge may be located/positioned at one edge of the slot (e.g. substantially adjacent the chamfer C) (see e.g. FIG. 18A); the ridge may be located/positioned within the slot (e.g. with a depression D substantially adjacent the chamfer C) (see e.g. FIG. 18G). According to an exemplary embodiment, the ridge may comprise 10 to 90 percent of the slot in a range (with the depression comprising 90 to 10 percent of the slot in the range); the ridge/depression size relationship may be provided in various other proportions (percentage/percentage division of ridge/depression) such as 15/85, 20/80, 25/75, 30/70, 40/60, 50/50, 60/40, 70/30, 75/25, 80/20, 85/15, etc. See e.g. FIGS. 17, 17A-17D and 17F (showing schematically differing various proportions/relationships of the ridge/depression arrangement to occupy varying portions of the exposed surface/area of the slot to be engaged by an installed archwire). See also FIGS. 17E, 18 and 18A-18I. As indicated schematically in FIGS. 18D, 18E, 18F and 18H, the ridge arrangement may be provided in a composite form with multiple projecting ridge segments that function to provide an effective width/size (dimension) for the ridge arrangement. According to any exemplary embodiment, the configuration/proportion/relationship of the ridge/depression arrangement (e.g. area proportion, selective location, relative proportion/location, etc.) within a range may be selected (e.g. collectively, sequentially, individually or in a selected/other manner for each bracket) in the conditions of treatment with the intent to achieve an optimization of archwire engagement for precision tooth movement (e.g in a configuration for application of forces F at intended precise locations to individual teeth during treatment).

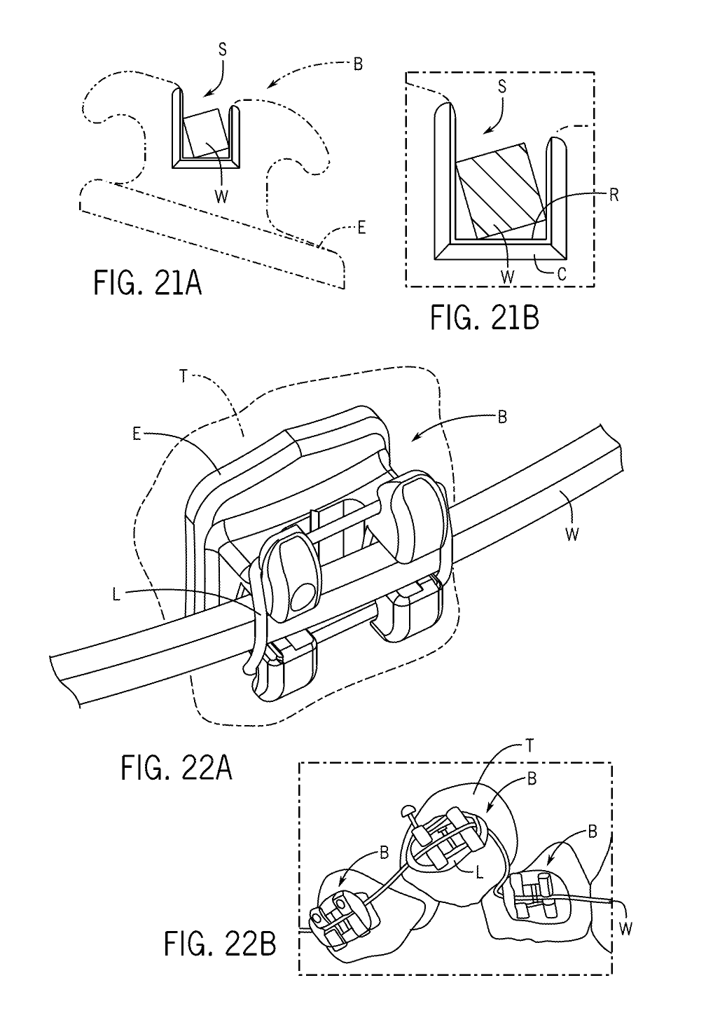

As shown schematically and representationally in FIGS. 17, 17A-17D and 18, 18A-18I, according to exemplary and alternative embodiments, the ridge/depression configuration may be provided with various forms and shapes and proportional relationships including composite forms (e.g. having multiple ridge-projections as indicated in FIGS. 18D-18F and 18H). According to an exemplary embodiment as indicated schematically in FIGS. 16A, 16B and 20B, the ridge configuration will facilitate precision (e.g. directed positioning/location) of force/force vectors applied by the wire to the bracket and individual tooth; as indicated schematically (e.g. compare FIG. 6 and FIG. 20B), the size or configuration of the bracket with the ridge configuration may be adapted or modified within a particular application/treatment (e.g. using combinations of differently configured/sized brackets to fit different types/sizes of individual teeth of the patient or patients) or to facilitate a treatment plan (e.g. using combinations of differently configured/sized brackets to facilitate selective variations of force/treatment to be applied to individual teeth of the patient or patients).

Referring to FIG. 20A, a bracket with a slot but no ridge/depression arrangement is indicated schematically (e.g. where the wire would be retained generally within the slot and forces from the wire would be applied generally to the bracket); referring to FIG. 20B a bracket with a ridge/depression arrangement within the slot is indicated schematically (e.g. where forces from by the wire would be applied at specific/precise locations of the ridges within the slot to the bracket and the overall bearing area of the wire is reduced) (see also FIGS. 21A-21B). As indicated schematically according to an exemplary embodiment, a bracket B with a ridge R as shown for example in FIGS. 1, 3, 6, 9, 16, 20B and 21A-21B facilitates the more precise location of force/force vectors between the archwire W and the bracket B and tooth T (in comparison with a bracket as shown in FIG. 20A without a ridge/depression arrangement, schematically/representationally indicating a conventional bracket design where the bearing/friction surface and force application area for the wire may comprise more of the slot or substantially the entire slot).

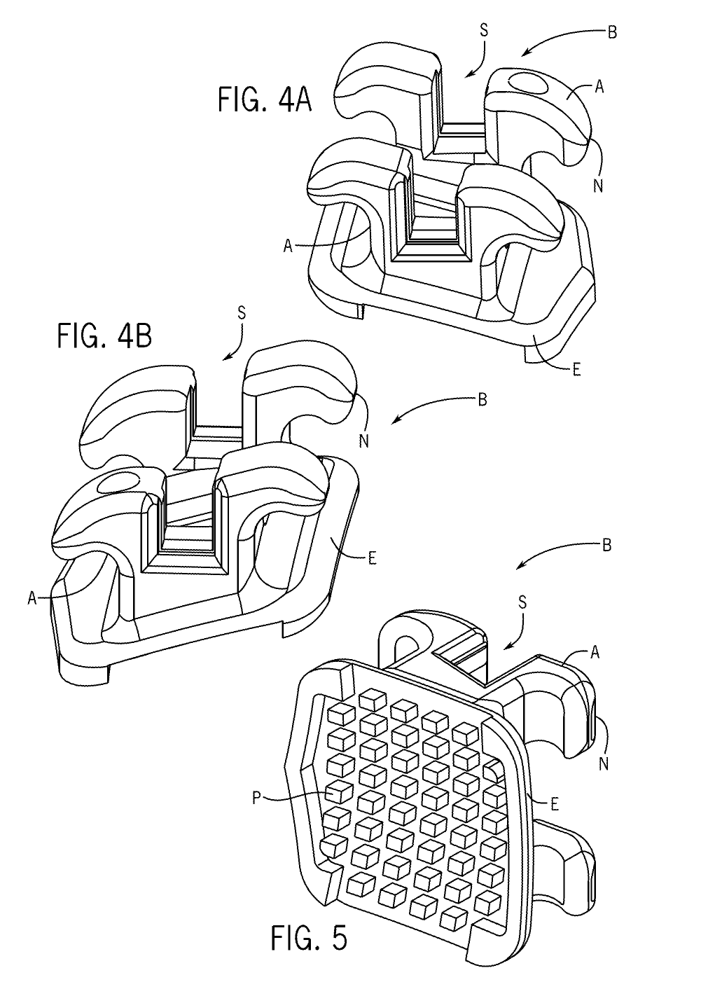

As indicated in FIGS. 3-3A and 4A-4B, according to an exemplary embodiment, the depression D (or reduced saddle area) relative to the ridge R may reduce contact area with the wire by approximately 70 percent in comparison with a conventional mini-twin bracket design (compare FIGS. 3 and 20A). According to a preferred embodiment, as indicated in FIGURES, the intended effect of the ridge/depression of the bracket B, reduce contact friction or “drag” and allow improved wire function with inter-arch and intra-arch tooth movement. As indicated in FIGS. 16A, 16B, 16C, 16D and 21B (for example), the force asserted by the archwire when installed in the slot acts at the points of contact of the archwire with the ridge arrangement (e.g. as specifically located with the parts of contact at each bracket).

Anti-Rotation Control/Optimum Torque and Tip Control.

As indicated schematically in FIG. 10A, tooth movement in orthodontic treatment comprises movement in three dimensions (e.g. on X-Y-Z axes); movement of a tooth may comprise lateral movement and rotation of a tooth relative to axes (e.g. X-Y-Z axes as indicated). The bracket B with ridge R facilitates enhanced precision in application of force F to each tooth T. See FIGS. 16 and 16A/D. See also FIGS. 12, 12A-12B, 15A-15B, 16A-16D, 17A-17F and 18A-18I.

As indicated, enhanced precision in coupling force F to the bracket B and tooth T provides improved rotation control of the tooth T (e.g. avoiding or reducing undesirable tooth rotation), improved control/application of torque to the tooth T, and improved control/application of force at the bracket tip. See e.g. FIGS. 10B and 12-12B.

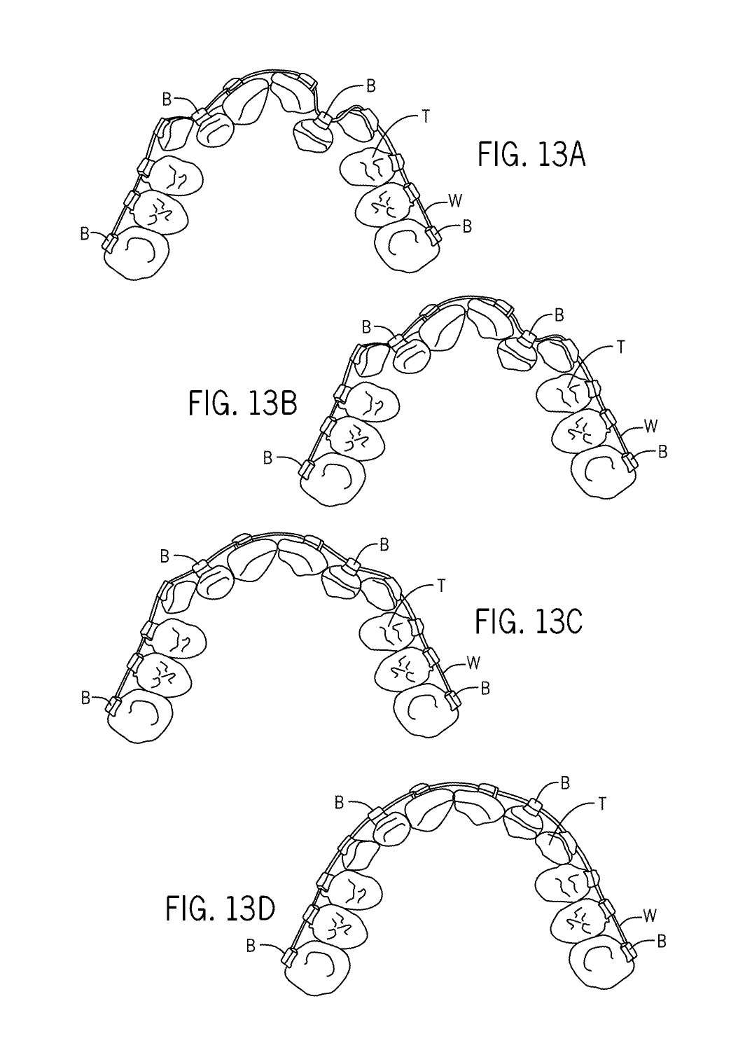

According to any preferred embodiment, the bracket is intended to facilitate the application of an optimum force level for desired tooth movement according to a treatment plan/gradient, through the stages of treatment (e.g. start of tooth movement/capillary compression/occlusion through hyalinization of bone as tooth movement slows or stops for the end of treatment). Progression of orthodontic treatment using the apparatus and method according to an exemplary embodiment is shown schematically in FIGS. 13A (start of tooth movement) through 13D (completion of treatment). As indicated schematically, variations in the brackets and slots with ridge-depression arrangement can be provided selectively (e.g. at a specific tooth or specific teeth or for sets of teeth).

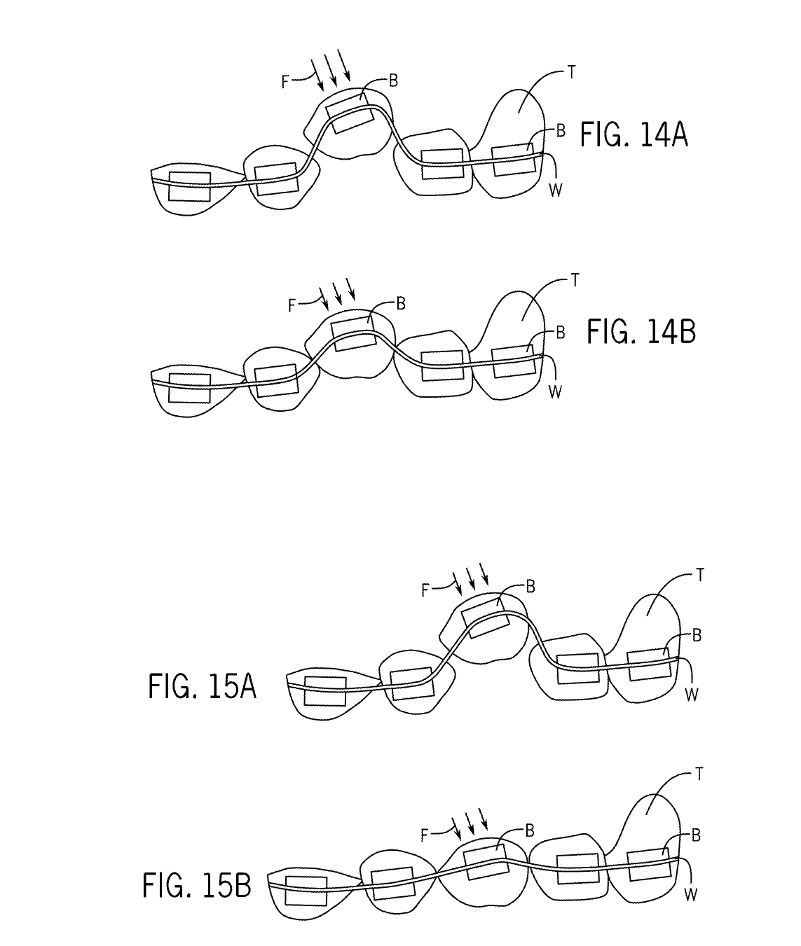

As indicated schematically in FIGS. 14A-14B and 15A-15B, the efficiency of tooth movement can be achieved more fully when forces F can be applied more efficiently from the archwire W to the bracket B and tooth T; compare FIGS. 14A-14B showing reduced efficiency tooth movement that may require greater force and/or a longer period of time of treatment in contrast to FIGS. 15A-15B showing more efficient tooth movement that will require less force and/or a shorter period of time of treatment. As indicated schematically in FIGS. 14A-14B, in a conventional bracket configuration the performance may be slower with inconsistent tooth movement due to more friction (requiring more force) and overall slowed treatment. As indicated schematically in FIGS. 15A-15B, with the apparatus and method according to an exemplary embodiment with bracket B with archwire W activated in a more radial manner the intended result of treatment is faster, healthier tooth movement with less friction (less force required) and overall more rapid treatment (e.g. as teeth rotate/slide along the archwire according to treatment).

According to any preferred embodiment, the apparatus and method is intended to provide optimum force levels for tooth movement of each type of tooth: (a) anterior teeth (small rooted teeth) and (b) canines/premolars (medium rooted teeth) and (c) molars (large rooted teeth). To facilitate a treatment plan according to an exemplary embodiment of the method, archwire sequence and selection (e.g. sizing, material, etc.) can be provided for various phases of treatment (e.g. including alignment phase (stage 1), working phase (stage 2) and finishing phase (stage 3)). According to any exemplary embodiment, the apparatus and method and the bracket can be configured for treatment of any of a wide variety of conditions including for example severe crowding, moderate crowding, mild crowding, space closure, bite opening correction, overjet reduction, molar alignment, detailing, finishing, etc.

According to an exemplary embodiment, as shown schematically in FIGS. 19A and 19B, the bracket B with chamfer C in slot S for archwire W (see FIG. 19B) will in comparison with a conventional bracket configuration (see FIG. 19A) achieve advantages of facilitating a more radial deformation of the archwire (see FIG. 19B with radially curved archwire around the chamfer) as opposed to a less efficient deformation of the archwire (see FIG. 19A with kinking archwire that may be deformed past elastic limit at a sharp edge); the intent is to achieve enhanced performance and efficiency of the archwire in the chamfered slot design (e.g. including by reducing undesired stress/deformation of the wire).

According to an exemplary embodiment, as shown schematically in FIGS. 1, 13A-13D, 15A-15B, 16 and 16A-16D, a longer inter-bracket distance facilitates archwire flexibility and installation of the archwire W into the slot S (see e.g. FIG. 9). A shorter inter-bracket distance decreases archwire flexibility and makes it more difficult to engage an archwire into the slot. According to an exemplary embodiment as shown schematically in FIGS. 1, 13A-13D, 15A-15B, 16, 16A and 16D (indicating inter-bracket distance), the effective distance between force vectors/forces F acting on individual brackets during treatment can managed by selection and configuration of the ridge/depression arrangement of the brackets.

According to a preferred embodiment the apparatus and method is intended to facilitate enhancement of orthodontic treatment by facilitating greater precision in the force vector locations with engagement of archwire on ridge areas with improved “anti-rotation” control of tooth movement. Archwire sizes of any of a wide range may be accommodated in the slot of the bracket according to exemplary embodiments (e.g. 018×025 wire, 017×025 wire, etc.).

The slot of the bracket may be provided in any of a number of various configurations according to alternative embodiments; the bracket shape and configuration may also be provided in any of a number of various configurations according to alternative embodiments implementing the apparatus and method.

According to any exemplary embodiments, the brackets may be mounted or affixed to the teeth by any means or method including conventional methods (e.g. affixed with pads P using a resin or the like) or means/methods that may be developed or used in the future; the brackets may be interconnected using archwires of a conventional type or other wires or the like that may be developed or used in the future for orthodontic treatment; ligation of the brackets maybe by any suitable means or method including conventional methods (see e.g. FIGS. 22A and 22B) (ligation L) or means/methods that may be developed or used in the future.

The content of any and all specification/drawing (including appendix material) filed with the related provisional applications (U.S. Provisional Application No. 61/935,329 titled “Apparatus and Method for Orthodontic Treatment” and U.S. Provisional Application No. 61/936,320 titled “Apparatus and Method for Orthodontic Treatment”) is incorporated by reference into the present application.

It is important to note that the construction and arrangement of the elements of the inventions as described in system and method and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, variations in the arrangement or sequence of process/method steps, operating conditions and arrangement of the preferred and other exemplary embodiments without departing from the spirit of the present inventions.

It is important to note that the system and method of the present inventions can comprise conventional or any other applicable technology (present or future) that has the capability to perform the functions and processes/operations indicated in the specification including the FIGURES. All such technology is considered to be within the scope of the present inventions.

1. An orthodontic apparatus comprising a bracket configured for attachment to a tooth in a set of brackets configured for attachment to a set of teeth and configured to be engaged by an archwire installed in the set of brackets to facilitate orthodontic treatment comprising:
a base for attachment to the tooth;
at least one slot for the archwire with a ridge and a depression and a chamfer;
wherein the ridge of the slot is configured to engage in contact with the archwire so that force from the archwire is applied by contact at the ridge to the bracket and treatment is facilitated by selectively located application of force from the archwire to the tooth at the ridge when the bracket is attached to the tooth and the archwire is installed in the set of brackets.

2. The apparatus of claim 1 further comprising at least one arm projecting from the base; wherein the at least one slot is provided in an arm.

3. The apparatus of claim 1 wherein each bracket in the set of brackets is configured to be attached to a tooth and is provided with the ridge and the depression in the slot in an arrangement intended to facilitate application of force for desired positioning of each tooth.

4. The apparatus of claim 1 wherein the chamfer comprises a lead in chamfer rounded to reduce stress in the archwire.

5. The apparatus of claim 1 wherein a distance between each ridge of each adjacent bracket in the set of brackets comprises an inter-bracket distance that can be adjusted to facilitate installation of the archwire into the slot of the adjacent brackets.

6. The apparatus of claim 1 wherein the ridge is at one edge of the slot substantially adjacent to a chamfer.

7. The apparatus of claim 1 wherein the ridge and the depression comprise a ridge-depression arrangement comprising an area in a portion of the slot within the chamfer provided in a relationship of between about 20 percent ridge and about 80 percent depression to between about 80 percent ridge and about 20 percent depression.

8. An orthodontic apparatus comprising a bracket set for a set of teeth configured to engage an archwire for orthodontic treatment comprising:
a bracket with a base for attachment to a tooth and at least one slot;
wherein a slot comprises:
(a) at least one edge with a chamfer;
(b) at least one ridge;
(c) at least one depression;
wherein the at least one ridge of the slot is configured to engage the archwire when in the slot so that force from the archwire is applied in contact with the at least one ridge to the bracket;
wherein each bracket in the set of brackets is attachable to a tooth and can be configured with the at least one ridge and at least one depression located within the slot so that treatment is facilitated by selectively located force from the archwire engaged in contact with the at least one ridge in the at least one slot of each bracket.

9. The apparatus of claim 8 wherein the at least one ridge comprises a ridge and the at least one depression comprises a depression to provide an anti-saddle area in the slot for the archwire in which the ridge engages the archwire and the depression does not engage the archwire.

10. The apparatus of claim 8 wherein the configuration of the at least one ridge and the at least one depression in each bracket can be selected during treatment to achieve improved performance; wherein improved performance comprises increased efficiency of the archwire and the treatment by selectively located application of force from the archwire to the bracket and tooth.

11. The apparatus of claim 8 wherein the bracket comprises a set of chamfers for the slot for the archwire.

12. The apparatus of claim 8 wherein the chamfer comprises a lead in chamfer.

13. The apparatus of claim 8 wherein the at least one ridge and the at least one depression comprise a ridge-depression arrangement in a portion of the slot provided in a relationship of between about 20 percent ridge and about 80 percent depression to between about 80 percent ridge and about 20 percent depression.

14. A method of providing orthodontic treatment using a set of brackets for a set of teeth connected by an archwire comprising the steps of:
(a) configuring each bracket in the set of brackets with a ridge-depression arrangement providing a ridge in a slot;
(b) attaching each bracket to a tooth;
(c) connecting the set of brackets with an archwire inserted in the slot;
wherein the ridge of the slot is configured to engage the archwire so that force from the archwire is applied at the ridge to the bracket and the tooth;
wherein the treatment is facilitated by selectively located application of force from the archwire to the ridge to the bracket when the bracket is attached to the tooth.

15. The method of claim 14 further comprising the step of attaching the archwire in the slot of the bracket to engage the ridge as to provide at the tooth: rotation control; torque; and tip control.

16. The method of claim 14 wherein the ridge-depression arrangement of each bracket comprises at least one ridge and at least one depression.

17. The method of claim 14 wherein each bracket in the set of brackets can be adapted in design with the ridge-depression arrangement to specifically locate force on the attached tooth of the bracket to improve performance and efficiency of the treatment.

18. The method of claim 14 wherein at least one bracket is intended to facilitate the application of force for desired tooth movement through the stages of treatment; wherein the at least one ridge comprises a ridge and the at least one depression comprises a depression so that the archwire in the slot engages the ridge but does not engage the depression.

19. The method of claim 14 wherein an archwire selection sequence can be provided for treatment during alignment phase, working phase and finishing phase and wherein positioning in treatment comprises movement in three dimensions facilitated by the set of brackets to effect lateral movement and rotation of a tooth relative to axes according to a treatment plan.

20. The method of claim 14 wherein the at least one ridge and the at least one depression comprise a ridge-depression arrangement comprising a portion of area in the slot provided separate from the chamfer in a relationship of between about 25 percent ridge and about 75 percent depression to between about 75 percent ridge and about 25 percent depression.
